(19) United States
(12) Patent Application Publication
(10) Pub. No.: US 2026/0023602 A1
(43) Pub. Date: Jan. 22, 2026

(54) INFORMATION PROCESSING APPARATUS, ALLOCATION METHOD, AND RECORDING MEDIUM

(71) Applicant: NEC Corporation, Tokyo (JP)

(72) Inventors: Masahiro SERIZAWA, Tokyo (JP); Masahiro IWADARE, Tokyo (JP); Akio YOSHIOKA, Tokyo (JP); Shinnosuke NISHIMOTO, Tokyo (JP)

(73) Assignee: NEC Corporation, Tokyo (JP)

(21) Appl. No.: 19/252,431

(22) Filed: Jun. 27, 2025

(30) Foreign Application Priority Data
Jul. 18, 2024 (JP) 2024-115037

(51) Int. Cl. G06F 9/50

(52) U.S. Cl. CPC G06F 9/5005; G06F 2209/5017

(57) ABSTRACT

An information processing apparatus includes an evaluation result acquisition unit for acquiring an evaluation result obtained by evaluating a plurality of generative models subjected to machine learning in such a way as to execute a given task and generate a deliverable; and an allocation unit for decision making to determine a plurality of generative models to be allocated to a target task to be executed based on the evaluation result regarding the target task.

This application is based upon and claims the benefit of priority from Japanese Patent Application No. 2024-115037, filed on Jul. 18, 2024 the disclosure of which is incorporated herein in its entirety by reference.

### TECHNICAL FIELD

The present disclosure relates to an information processing apparatus and the like.

### BACKGROUND ART

Attempts have been made to apply artificial intelligence (AI) to various fields. For example, JP 2019-8483 A discloses AI that communicates with a user.

### SUMMARY

An exemplary object of the present disclosure is to provide a technique capable of appropriately allocating a plurality of generative models to a task to be executed.

An information processing apparatus according to one exemplary aspect of the present disclosure includes an evaluation result acquisition unit that acquires an evaluation result obtained by evaluating a plurality of generative models subjected to machine learning in such a way as to execute a given task and generate a deliverable; and an allocation unit that determines a plurality of generative models to be allocated to a target task to be executed based on the evaluation result regarding the target task.

An allocation method according to an exemplary aspect of the present disclosure, causes at least one processor to execute:
evaluation result acquisition processing for acquiring an evaluation result obtained by evaluating a plurality of generative models subjected to machine learning in such a way as to execute a given task and generate a deliverable; and
allocation processing for determining a plurality of generative models to be allocated to a target task to be executed based on the evaluation result regarding the target task.

A non-transitory recording medium according to an aspect of the present disclosure recording an allocation program for causing a computer to execute:
evaluation result acquisition step of acquiring an evaluation result obtained by evaluating a plurality of generative models subjected to machine learning in such a way as to execute a given task and generate a deliverable; and
allocation step of determining a plurality of generative models to be allocated to a target task to be executed based on the evaluation result regarding the target task.

### BRIEF DESCRIPTION OF THE DRAWINGS

FIG. 1 is a block diagram illustrating a configuration of an information processing apparatus according to the present disclosure;

FIG. 2 is a flowchart illustrating a flow of an allocation method according to the present disclosure;

FIG. 3 is a block diagram illustrating a configuration of another information processing apparatus according to the present disclosure;

FIG. 4 is a diagram illustrating an example of a user interface (UI) screen that accepts designation of a generative model;

FIG. 5 is a diagram illustrating an example in which allocation of a generative model is changed;

FIG. 6 is a flowchart illustrating a flow of processing executed by the information processing apparatus illustrated in FIG. 3; and

FIG. 7 is a block diagram illustrating a configuration of a computer that functions as an information processing apparatus according to the present disclosure.

### EXAMPLE EMBODIMENT

Hereinafter, example embodiments of the present disclosure will be described. However, the present disclosure is not limited to the example embodiments described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Effects mentioned in the following example embodiments are examples of effects expected in the example embodiments, and do not define the extension of the present disclosure. That is, example embodiments that do not achieve the advantages mentioned in the following example embodiments can also be included in the scope of the present disclosure.

### First Example Embodiment

A first example embodiment that is an example embodiment of the present disclosure will be described in detail with reference to the drawings. The present example embodiment is a basic form of each example embodiment described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in the drawings referred to for describing the present example embodiment can also be employed in the other example embodiments included in the present disclosure within a range in which no particular technical problem occurs.

### (Configuration of Information Processing Apparatus 1)

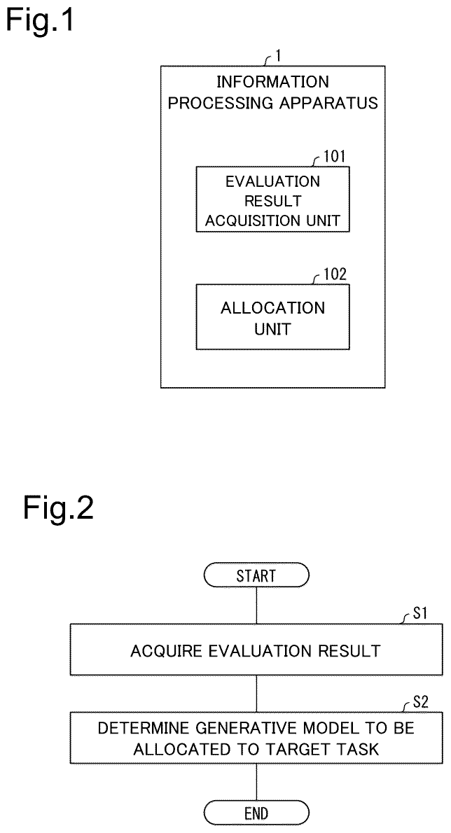

A configuration of an information processing apparatus 1 according to the present example embodiment will be described with reference to FIG. 1. FIG. 1 is a block diagram illustrating a configuration of the information processing apparatus 1. As illustrated in FIG. 1, the information processing apparatus 1 includes an evaluation result acquisition unit 101 and an allocation unit 102.

The evaluation result acquisition unit 101 acquires an evaluation result obtained by evaluating a plurality of generative models machine-learned to execute a given task and generate a deliverable. Any method of acquiring the evaluation result is applicable. For example, the evaluation result acquisition unit 101 may acquire the evaluation result by evaluating each generative model. For example, the evaluation result acquisition unit 101 may acquire an evaluation result generated by the information processing apparatus 1 or another apparatus.

Here, the “generative model” may be a learned model machine-learned in such a way as to execute a given task and generate a deliverable, and the “task” and the “deliverable” are optional.

For example, in a case where the task is to generate an answer to an input question, the deliverable is an answer generated by the generative model. In a case where such a task is executed, a language model obtained by machine learning the arrangement of components (words and the like) in a sentence or the arrangement of a sentence and a sentence in a text may be applied as the generative model. For example, a generative pre-trained transformer (GPT) that outputs a sentence including an input character string by predicting a character string having a high probability of following the input character string may be used as the above generative model. In addition, for example, a text-to-text transfer transformer (T5), bidirectional encoder representations from transformers (BERT), a robustly optimized BERT approach (ROBERTa), or efficiently learning an encoder that classifies token replacements accurately (ELECTRA), or the like may be used as the above generative model.

For example, in a case of generating an explanatory sentence of an image to which the task is input, the deliverable is an explanatory sentence generated by the generative model. In a case where such a task is executed, a model that generates an explanatory sentence from an input image generated by machine learning of a relationship between an image and a text indicating the content of the image may be applied as the generative model. For example, BLIP (Bootstrap Language Image Pre-Training) can be used as a generative model for generating an explanatory sentence of a still image, and Video-LLaVa or the like can be used as a generative model for generating an explanatory sentence of a moving image.

For example, in a case where the task is to generate an image associated with the content of the input text, the deliverable is an image generated by the generative model. In a case where such a task is executed, a model that generates an image associated with the content from the input text generated by machine learning the relationship between the text and the image associated with the content of the text may be applied as the generative model.

The “evaluation” may be any evaluation result that serves as a determination material for determining a generative model to be allocated to a target task to be described later. For example, in a case where the target task includes a process of generating an answer to a question, the evaluation result acquisition unit 101 may acquire an evaluation result obtained by evaluating the accuracy of the answer to the question.

The “plurality of generative models” also includes a generative model whose output tendency is changed by prompt engineering. For example, a case where a general-purpose language model is applied as the above-described generative model, and a task of generating an answer to a question is executed by the language model will be considered. In this case, the tendency of the generated answer is different between a case where the sentence “Please answer in an easy-to-understand manner to the extent that even middle school students can understand.” is included and a case where the sentence is not included in the prompt input to the language model. Therefore, in a case where this sentence is included in the prompt and the language model is used and in a case where this sentence is not included in the prompt and the language model is used, it can be considered that different generative models are caused to execute the task.

One generative model 111A can be caused to function as a plurality of generative models 111A by referring to predetermined data or a database when generating an output. The “plurality of generative models” includes a generative model in which a tendency of output is changed by referring to predetermined data or a database.

The allocation unit 102 determines a plurality of generative models to be allocated to the target task based on the evaluation result regarding the target task to be executed among the evaluation results acquired by the evaluation result acquisition unit 101. The target task only needs to be a task that can be executed using all or some of the plurality of evaluated generative models. For example, the target task may include a plurality of processes each executable by one or a plurality of generative models. In this case, the deliverable as the entire target task is obtained by causing the generative model to generate the deliverable in each process.

As described above, the information processing apparatus 1 according to the present example embodiment includes the evaluation result acquisition unit 101 for acquiring an evaluation result obtained by evaluating a plurality of generative models subjected to machine learning in such a way as to execute a given task and generate a deliverable, and the allocation unit 102 for determining a plurality of generative models to be allocated to a target task to be executed based on the evaluation result regarding the target task.

Therefore, according to the information processing apparatus 1, it is possible to appropriately allocate a plurality of generative models to the task to be executed. For example, according to the information processing apparatus 1, it is also possible to optimize the generative model to be allocated to the target task.

### (Allocation Program)

The above-described functions of the information processing apparatus 1 can also be achieved by a program. The allocation program according to the present example embodiment causes a computer to function as evaluation result acquisition means for acquiring an evaluation result obtained by evaluating a plurality of generative models subjected to machine learning in such a way as to execute a given task and generate a deliverable, and allocation means for determining a plurality of generative models to be allocated to a target task to be executed based on the evaluation result regarding the target task. According to this allocation program, it is possible to appropriately allocate a plurality of generative models to the task to be executed.

### (Flow of Allocation Method)

A flow of an allocation method according to the present example embodiment will be described with reference to FIG. 2. FIG. 2 is a flowchart illustrating a flow of an allocation method. An executing entity of each step in this allocation method may be a processor included in the information processing apparatus 1, may be a processor included in another apparatus, or may be a processor provided in an apparatus in which executing entities of each step are different.

In S1 (evaluation result acquisition processing), at least one processor acquires an evaluation result obtained by evaluating a plurality of generative models machine-learned to execute a given task and generate a deliverable.

In S2 (allocation processing), at least one processor determines a plurality of generative models to be allocated to the target task based on the evaluation result regarding the target task to be executed among the evaluation results acquired in S1.

As described above, the allocation method according to the present example embodiment causes at least one processor to execute evaluation result acquisition processing for acquiring an evaluation result obtained by evaluating a plurality of generative models subjected to machine learning in such a way as to execute a given task and generate a deliverable, and allocation processing for determining a plurality of generative models to be allocated to a target task to be executed based on the evaluation result regarding the target task. Therefore, according to the allocation method according to the present example embodiment, it is possible to appropriately allocate a plurality of generative models to the task to be executed.

### Second Example Embodiment

A second example embodiment, which is an example of an example embodiment of the present disclosure, will be described in detail with reference to the drawings. Components having the same functions as the components described in the above-described example embodiment will be denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within a range in which no particular technical problem occurs.

### (Configuration of Information Processing Apparatus 1A)

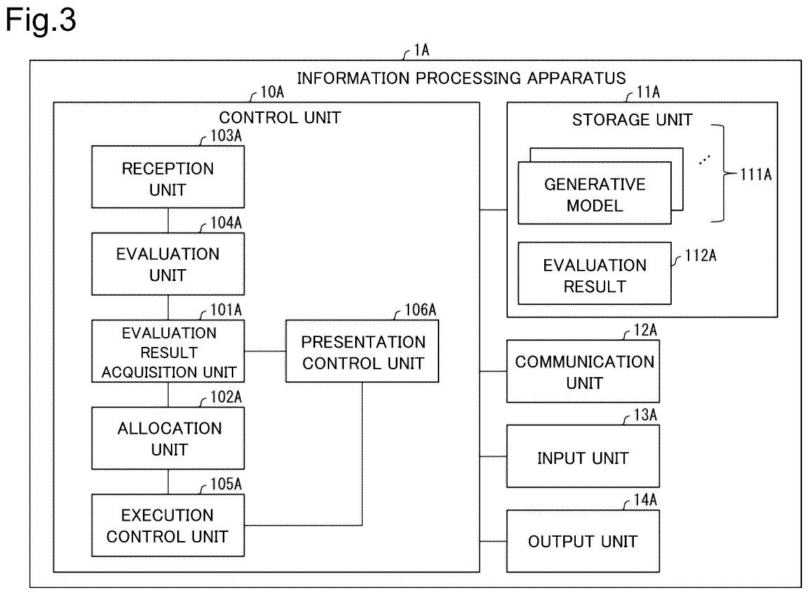

A configuration of an information processing apparatus 1A according to the present example embodiment will be described with reference to FIG. 3. FIG. 3 is a block diagram illustrating the configuration of the information processing apparatus 1A. The information processing apparatus 1A is an apparatus having a function of allocating a generative model to a target task that is an execution target. The information processing apparatus 1A may be an apparatus having allocation of a generative model as a main function, or may be a general-purpose apparatus having other functions. The information processing apparatus 1A may be a stationary apparatus or a portable apparatus.

As illustrated, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that accepts an input to the information processing apparatus 1A, and an output unit 14A for the information processing apparatus 1A to output data. Then, the control unit 10A includes an evaluation result acquisition unit 101A, an allocation unit 102A, an acceptance unit 103A, an evaluation unit 104A, an execution control unit 105A, and a presentation control unit 106A. The storage unit 11A stores a plurality of generative models 111A and evaluation results 112A.

Similarly to the evaluation result acquisition unit 101 according to the first example embodiment, the evaluation result acquisition unit 101A acquires an evaluation result obtained by evaluating a plurality of generative models 111A machine-learned to execute a given task and generate a deliverable. Specifically, the evaluation result acquisition unit 101A acquires an evaluation results 112A, which are data indicating the evaluation results of the plurality of generative models 111A by the evaluation unit 104A, from the storage unit 11A.

The generative model 111A is a learned model machine-learned to execute a given task and generate a deliverable, similarly to the generative model described in the first example embodiment. The storage unit 11A of the information processing apparatus 1A illustrated in FIG. 3 stores a plurality of generative models 111A. The generative model 111A does not necessarily need to be stored in the storage unit 11A, and the generative model 111A outside the information processing apparatus 1A can also be used.

Similarly to the allocation unit 102 according to the first example embodiment, the allocation unit 102A determines a plurality of generative models 111A to be allocated to the target task, based on the evaluation result regarding the target task to be executed among the evaluation results obtained by the evaluation result acquisition unit 101A. A specific method of allocation will be described later.

The acceptance unit 103A accepts an input from the user of the information processing apparatus 1A. For example, the acceptance unit 103A can also accept designation of the generative model 111A to be allocated to the target task.

For example, the acceptance unit 103A can also accept an instruction to change the generative model 111A to be allocated to the target task.

The evaluation unit 104A evaluates the generative model 111A. The evaluation result of the generative model 111A by the evaluation unit 104A is stored in the storage unit 11A as an evaluation result 112A. Details of the evaluation method applied by the evaluation unit 104A will be described later.

The execution control unit 105A causes the generative model 111A to execute the target task according to the allocation determined by the allocation unit 102A. Details of processing for causing the generative model 111A to execute a task will be described later.

The presentation control unit 106A presents various types of information to the user of the information processing apparatus 1A. For example, the presentation control unit 106A can present the evaluation result 112A to the user. For example, the presentation control unit 106A can present the deliverable generated by the generative model 111A in each of the plurality of processes included in the target task to the user. A method and an aspect of the presentation are optional. For example, the presentation control unit 106A can present information by causing the output unit 14A to output the information, or can present information by causing a device other than the information processing apparatus 1A to output the information via the communication unit 12A. The presentation control unit 106A may present information by displaying and outputting the information, or may present the information by voice output, print output, or the like.

As described above, similarly to the information processing apparatus 1 of the first example embodiment, the information processing apparatus 1A includes: the evaluation result acquisition unit 101A for acquiring the evaluation result 112A obtained by evaluating the plurality of generative models 111A machine-learned to execute a given task and generate a deliverable; and the allocation unit 102A for determining the plurality of generative models 111A to be allocated to the target task based on the evaluation result regarding the target task to be executed. Therefore, it is possible to appropriately allocate the plurality of generative models 111A to the task to be executed.

### (Use Case)

That the target task is optional is as described in the first example embodiment. For example, the target task may be to propose a coping method according to patient's symptom. In this case, the information processing apparatus 1A allocates, to the target task, the generative model 111A having an excellent function of getting out the patient's symptom, the generative model 111A having an excellent function of estimating a coping method according to the symptom, and the like. This makes it possible to propose an appropriate coping method according to the patient's symptom. As described above, the information processing apparatus 1A can also be applied to the medical field.

The information processing apparatus 1A can also be applied to support execution of business in an organization including a plurality of members such as a company. In this case, for example, by preparing the generative model 111A associated with each member, it is possible to cause the generative model 111A associated with each member to execute the target task in a similar manner to the case where the members form a team and execute the task.

For example, it can also be used to create new ideas and solve problems between members.

It is also possible to consider the actual allocation of the members with reference to the allocation by the information processing apparatus 1A. For example, regarding the combination of the generative models 111A in which the execution result of the target task is good, the information processing apparatus 1A may present the combination of the members based on the generative model 111A to the user as a combination suitable for execution of the target task or a task of the same type as the target task. The evaluation result of the generative model 111A can also be used to grasp the characteristics of the members on which the generative model 111A is based. For example, in a case where an evaluation result indicating that the accuracy of an answer to a question in a specific technical field is high is obtained for a certain generative model 111A, the information processing apparatus 1A may output an estimation result indicating that the technical field is a favorite field of the member who is the basis of the generative model 111A.

The information processing apparatus 1A can also be applied to learning assistance in a community. In this case, the generative model 111A associated with each affiliation member of the community may be prepared. As a result, it is also possible to cause the generative model 111A to serve as a substitute for the discussion held among the affiliation members or cause the generative model 111A to participate in the discussion. It is also possible to generate new knowledge from various viewpoints by allowing discussions to be conducted by a combination of the generative models 111A associated with affiliation members different in specialized fields. It is also possible to set generation of a question or an answer to a concern presented in a discussion performed between affiliation members as the target task. As a result, it is also possible to generate an appropriate answer by a combination of the generative models 111A suitable for generating an answer to such a question or concern. By analyzing each of the generative models 111A and evaluating their learning tendency, it is possible to visualize the knowledge learned by each of the generative models 111A. It can be said that such processing visualizes the knowledge distribution of the affiliation member associated with each generative model 111A.

The information processing apparatus 1A can also be applied to support creative activities and research and development.

For example, the generative models 111A associated with a plurality of creators such as authors and comics may be prepared. Then, the generation of a new work or a part thereof (for example, story development, character setting, and the like) may be set as a target task, and a plurality of generative models 111A may be allocated to the target task. As a result, it is possible to produce a new work that is not generated from one creator. For example, a novel work can be generated by a combination of the generative models 111A associated with creators and artists with different expertise, an incomplete work of the author can be completed by the generative model 111A associated with a dead author, and the like.

The same applies to the case of use in support of research and development. For example, the generative model 111A associated with various researchers in each field may be prepared. As a result, it is also possible to create an interdisciplinary research idea, interpret experimental data, or construct a hypothesis by combining the generative model 111A of a researcher in a different field and the generative model 111A of a different expert.

The information processing apparatus 1A can perform fine tuning of another generative model 111A using training data used for machine learning of a certain generative model 111A. For example, it is assumed that a new researcher is assigned to a certain research team. In this case, research know-how and the like in the research team are not learned in the generative model 111A of the new researcher at the time of assignment. Therefore, the generative model 111A of the new researcher is finely tuned using the training data used for the machine learning of the generative model 111A of the senior researcher of the research team. As a result, it is possible to cause the generative model 111A of the new researcher to generate a deliverable based on research know-how in the research team.

### (Regarding Plurality of Generative Models)

The plurality of generative models 111A to be allocated to the target task may be models generated independently. In this case, the model architectures of the respective generative models 111A may be common or may be different from each other. Training data used for machine learning of each generative model 111A may be prepared independently. For example, it is possible to generate the generative model 111A that generates a comment similar to that of a famous manager by performing machine learning using a collection of remarks of the famous manager as training data. It is possible to improve the accuracy of the generated comment by including various data sources including documents, reports, and the like directly or indirectly related to a famous manager in the training data.

The generative model 111A may be generated by finely tuning the base generative model using different training data sets. For example, a general-purpose language model may be finely tuned by a training data set including past statements of a specific person, documents created by the person in the past, and the like. As a result, it is possible to generate the generative model 111A that generates a comment similar to that of the person.

The generative model 111A may be generated by repeating processing of causing the generative model 111A to generate an output and giving feedback to the generated output to update the generative model 111A. For example, it is possible to generate the generative model 111A that generates a comment resembling a specific person by feeding back whether the comment generated by the generative model 111A is valid as the comment of the specific person.

As described in the first example embodiment, one generative model 111A can be caused to function as a plurality of generative models 111A by prompt engineering. As described in the first example embodiment, it is also possible to cause one generative model 111A to function as a plurality of generative models 111A by referring to predetermined data or a database when generating an output. For example, it is possible to generate an output reflecting the attribute, knowledge, experience, and the like of a specific person by causing a certain generative model 111A to refer to a database recorded regarding the attribute, knowledge, experience, and the like of the person. Therefore, by preparing such a database for each of a plurality of persons and causing the generative model 111A to refer to the database, it is possible to generate an output associated with each person.

As described above, the plurality of generative models 111A can be generated by various methods, and one generative model 111A can be caused to function as the plurality of generative models 111A. These methods can also be combined. For example, it is also possible to use the generative model 111A that is further improved in accuracy by feedback after fine tuning. Then, the generative model 111A associated with a real person (a model capable of generating an output similar to that of the person) can be generated. As a result, for example, it is also possible to construct a system that promotes knowledge sharing and knowledge utilization in an existing organization by preparing each generative model 111A associated with each member of the organization.

### (Evaluation Method)

An evaluation method applied by the evaluation unit 104A will be described. As described in the first example embodiment, any evaluation method can be applied as long as an evaluation result serving as a determination material for determining the generative model 111A to be allocated to the target task can be obtained.

For example, the structure (which can also be referred to as a model architecture) of the generative model 111A greatly affects the performance and the like of the generative model 111A. Therefore, the evaluation unit 104A may acquire information indicating the structure of the generative model 111A as an evaluation result or information for generating an evaluation result.

Examples of the information indicating the structure of the generative model 111A include an algorithm, the number of layers of the model, the type of each layer such as a convolutional layer and a fully connected layer, the presence or absence of an attention mechanism, the number of parameters, and a value of a hyperparameter. The hyperparameter may be, for example, a parameter indicating a learning rate, a batch size, the number of epochs, a type of optimizer, and the like.

The information as described above may be, for example, associated with each generative model 111A as metadata, or may be extracted from a predefined application programming interface (API), a serialized model file, or the like. The hyperparameters as described above can also be extracted from, for example, a training script or a setting file. By associating various hyperparameters with the performance and characteristics of the generative model 111A in advance, evaluation results of the performance and characteristics of the generative model 111A can be obtained from the values of the various hyperparameters.

Training data used for machine learning (including learning by fine tuning or feedback) of the generative model 111A determines characteristics of the generative model 111A. Therefore, the evaluation unit 104A may acquire information indicating an outline (for example, the domain, the data size, the language, the statistical information of each sample included in the training data, and the like) of the training data used for the machine learning of the generative model 111A as the evaluation result. The domain may be, for example, medical, legal, information technology (IT), or the like. The data size may be represented by, for example, the number of samples or the number of tokens. Such information can also be extracted from, for example, a meta information file or the like attached to the training data set.

The evaluation unit 104A may analyze the training data to evaluate the generative model 111A that has machine-learned the training data. For example, the evaluation unit 104A may analyze the properties (for example, text length, frequency of used terminology, data diversity, etc.) of each sample included in the training data, and evaluate the generative model 111A based on the analysis result.

The evaluation unit 104A may evaluate the generative model 111A by analyzing past input/output data with respect to the generative model 111A. For example, the evaluation unit 104A may analyze the length of the text, the frequency of used technical terms, the diversity of data, and the like for the data input to the generative model 111A or output from the generative model 111A.

The evaluation unit 104A may evaluate the content (for example, question response, document generation, coding support, and the like) of the content response of the output in the past output, the output accuracy (for example, correct answer rate), the output speed (for example, time required from generation start to completion), and the like. The past input/output data can be collected from, for example, a log file of API call or interaction. In a case where user feedback (for example, satisfaction level evaluation or the like) is performed on the output of the generative model 111A, the content of the feedback may also be taken into consideration in the evaluation.

The evaluation unit 104A can also estimate a task, a specialized field, a level of expertise, and the like that the generative model 111A is good at by analyzing past input/output data and training data of the generative model 111A. For example, the evaluation unit 104A can estimate a task or a specialized field that the generative model 111A is good at by using natural language processing technology such as topic modeling or keyword extraction.

The evaluation unit 104A may cause each of the plurality of generative models 111A to execute a standard task, and evaluate each generative model 111A from the execution result. As the standard task, for example, a task used in a known evaluation method may be applied. As a specific example, JGLUE (Japanese General Language Understanding Evaluation), which is a method for evaluating the performance of the natural language processing model, may be applied to the generative model 111A that inputs and outputs Japanese. The generative model 111A that inputs and outputs English may apply the generative model GLUE (General Language Understanding Evaluation). In these cases, the evaluation unit 104A evaluates the generative model 111A based on execution results such as a task of determining whether a hypothesis is associated with “true”, “false”, or “neutral” with respect to a sentence, a task of determining whether a sentence has a positive content or a negative content, a task of determining whether a plurality of sentences has the same meaning, and a task of identifying a proper noun in the sentence, for a pair of the sentence and the temporary sentence.

Since there is a correct answer to these tasks, the evaluation unit 104A may compare the correct answer with the output of the generative model 111A, calculate accuracy, a precision, a recall, an F1 score, and the like, and use the result as the evaluation result of the generative model 111A. The evaluation unit 104A may measure the time required to complete the task. In this case, the measured time is the evaluation result of the answer speed.

The evaluation unit 104A may evaluate the generative model 111A using, for example, an existing data set such as a common object in context (COCO) data set or the Stanford question answering dataset (SQUAD). The evaluation unit 104A can also evaluate the generative model 111A having a translation function by using an index such as Bilingual Evaluation Understudy (BLEU), Recall-Oriented Understudy for Gisting Evaluation (ROUGE), or METEOR.

In addition to this, the evaluation unit 104A may cause the generative model 111A to execute, for example, a task of generating an answer to an input question, a task of generating a summary of an input document, a task of generating a program code according to an input prompt, and the like. The evaluation criteria and the evaluation method of the execution result of the task may be determined in advance. For example, in the question answer task, a correct answer rate and a naturalness of the answer are used as references, and in the document summary task, accuracy and conciseness of the summary are used as references.

The evaluation unit 104A may select a plurality of tasks (evaluation tasks) associated with the target task and set a task set for evaluation. A plurality of types of task sets may be prepared in advance, and a task suitable for the target task may be selected and used from the task sets. In this case, each task set may have a specific purpose or theme and reflect an actual problem that the user may face.

The evaluation unit 104A may evaluate the generative model 111A by an evaluation method according to the modality of input and output of the generative model 111A. For example, the evaluation unit 104A may apply an evaluation method for evaluating the quality of an image to the generative model 111A that generates an image, and may apply an evaluation method for evaluating the quality of a voice to the generative model 111A that generates a voice.

The evaluation unit 104A may select the generative model 111A to execute the task before evaluating the generative model 111A by executing the task. For example, the evaluation unit 104A may select the generative model 111A based on information indicating the structure of each generative model 111A or the like, or may select the generative model 111A according to the target task in a case where the target task is determined. For example, in a case where the target task includes a process of performing translation, the evaluation unit 104A may select the generative model 111A having a translation function. In a case where the number of available generative models 111A is large, such selection may be performed.

The evaluation unit 104A may integrate a plurality of evaluation results to generate a final evaluation result. For example, the evaluation unit 104A may aggregate the evaluation scores obtained for each of the plurality of evaluation items to calculate a comprehensive evaluation score. When each evaluation score is aggregated, normalization processing may be performed. As a result, each generative model 111A can be evaluated with a consistent evaluation scale. For example, the evaluation unit 104A may estimate a specialized field or a specialized knowledge region of the generative model 111A from a plurality of evaluation results, and may use the estimation result as a final evaluation result.

The evaluation unit 104A stores the evaluation result as described above in the storage unit 11A as the evaluation result 112A. Then, the presentation control unit 106A presents the evaluation result 112A to the user. In the presentation of the evaluation result 112A to the user, the presentation control unit 106A may display the evaluation result 112A in a graph form. The presentation control unit 106A may present the evaluation result 112A using various data visualization tools. For example, the evaluation result 112A can be presented in various forms such as a dashboard by using a data visualization tool such as Grafana or Tableau.

### (Allocation Based on Evaluation Result)

The allocation unit 102A can automatically determine the generative model 111A to be allocated to the target task by using the evaluation result 112A generated as described above. For example, the allocation unit 102A may allocate, to the target task, the generative model 111A in which the evaluation result regarding the target task satisfies a predetermined condition among the plurality of generative models 111A from which the evaluation results have been acquired. As a result, in addition to the effect obtained by the information processing apparatus 1, it is possible to automatically determine the valid generative model 111A to be allocated to the target task.

The “predetermined condition” can be optionally set. For example, it is assumed that the evaluation result 112A indicates a score of 0 to 5 (higher evaluation as it is closer to 5) which is a comprehensive evaluation result obtained by aggregating evaluation results in a plurality of evaluation items. In this case, the “predetermined condition” may be selecting a predetermined number of generative models 111A having a score rank equal to or higher than a predetermined rank. For example, the “predetermined condition” may be selecting a predetermined number of generative models 111A whose scores are equal to or greater than a predetermined threshold.

The “predetermined condition” may be set for each of the plurality of processes included in the target task. The “predetermined condition” may be set in advance, or the “predetermined condition” may be set and changed by the user.

Information other than the evaluation result 112A may be considered for the allocation. For example, the allocation unit 102A may allocate the generative model to the target task based on the attribute information indicating the attribute of each of the plurality of generative models 111A. As a result, in addition to the effect obtained by the information processing apparatus 1, it is possible to obtain an effect of enabling allocation in consideration of the attribute of the generative model 111A.

As the attributes of the generative model 111A, for example, in addition to functional attributes such as having a translation function and having an image generation function, various attributes such as an attribute related to an input/output format such that a format of input data is limited to text and that both text and an image can be simultaneously input, and an attribute related to characteristics such as being appropriate in a legal field can be applied. In a case where there is a person associated with the generative model 111A, the attribute of the person (for example, age (group), sex, occupation, and the like) may be regarded as the attribute of the associated generative model 111A.

A method of allocation based on the attribute is optional. For example, a constraint regarding the attribute may be set as the above-described “predetermined condition”. For example, allocating only the generative model 111A having a predetermined attribute may be included in the “predetermined condition”, and conversely, allocating the generative model 111A having a different attribute to the target task may be included in the “predetermined condition”

The allocation unit 102A may determine allocation by using a language model. In that case, the allocation unit 102A may input the evaluation result 112A, the target task or the explanatory sentence thereof, and the attribute information about the generative model 111A as the allocation candidate to the language model together with a prompt for instructing to output the generative model 111A to be allocated to the target task in consideration of these pieces of information. As a result, information indicating the generative model 111A to be allocated to the target task is output from the language model.

In a case where the target task includes a plurality of processes, the allocation unit 102A may allocate the generative model 111A to each of the plurality of processes based on the evaluation result regarding each of the plurality of processes included in the target task. As a result, in addition to the effect obtained by the information processing apparatus 1, an effect that the appropriate generative model 111A can be allocated to each process of the target task can be obtained. The allocation unit 102A may allocate a plurality of generative models 111A to one process.

### (Execution Control of Target Task)

As described above, the execution control unit 105A causes the generative model 111A to execute the target task according to the allocation determined by the allocation unit 102A. Specifically, the execution control unit 105A generates a prompt for instructing to execute the target task (or a process included in the target task). Then, the execution control unit 105A inputs the generated prompt to the generative model 111A allocated to the target task (or a process included in the target task). As a result, a deliverable that is an execution result of the target task is output from the generative model 111A.

For example, it is assumed that the target task generates a document in a predetermined format, and includes a first process of summarizing content of an input article, a second process of generating a title according to the content of the summary, and a third process of generating a document by laying out the summary and the title.

In this case, the execution control unit 105A first inputs the above article to the generative model 111A allocated to the first process to generate a summary. Next, the execution control unit 105A inputs the generated summary to the generative model 111A allocated to the second process and generates a title according to the content. The summary generated in the first process and the title generated in the second process are intermediate deliverables in the target task. Then, the execution control unit 105A inputs a summary and a title, which are intermediate deliverables, to the generative model 111A allocated to the third process, and generates a document in which the summary and the title are laid out, that is, a final deliverable of the target task.

As described above, in a case where the deliverable of the previous process is used in the subsequent process, there may be a case where the deliverable of the previous process cannot be directly input to the generative model 111A used in the subsequent process. For example, there is a case where the generative model 111A used in the subsequent process can input only data in a text format, but the generative model 111A used in the preceding process generates a deliverable in a non-text format (for example, an image). In such a case, the execution control unit 105A may convert the data format of the deliverable in the previous process into a format that can be input to the generative model 111A in the subsequent process.

The allocation unit 102A may perform allocation in consideration of the input/output format of each generative model 111A and the usage order of each generative model 111A in such a way that the deliverable of the previous process can be used in the subsequent process without performing such conversion.

For example, it is assumed that the target task is planning of a new business, and includes a first process of exchanging ideas of the new business and a second process of generating presentation material of the presented ideas. In this case, the execution control unit 105A may input a prompt for requesting an idea of a new business to each of the plurality of generative models 111A allocated to the target task, and output the idea of the new business as a deliverable. Next, the execution control unit 105A may input a plurality of ideas, which are deliverables of the first process, to each of a plurality of generative models 111A allocated to the target task, and may generate presentation material of each idea based on other ideas. As described above, it is also possible to cause the target task to be executed without allocating the generative model 111A for each process.

### (UI Screen Example)

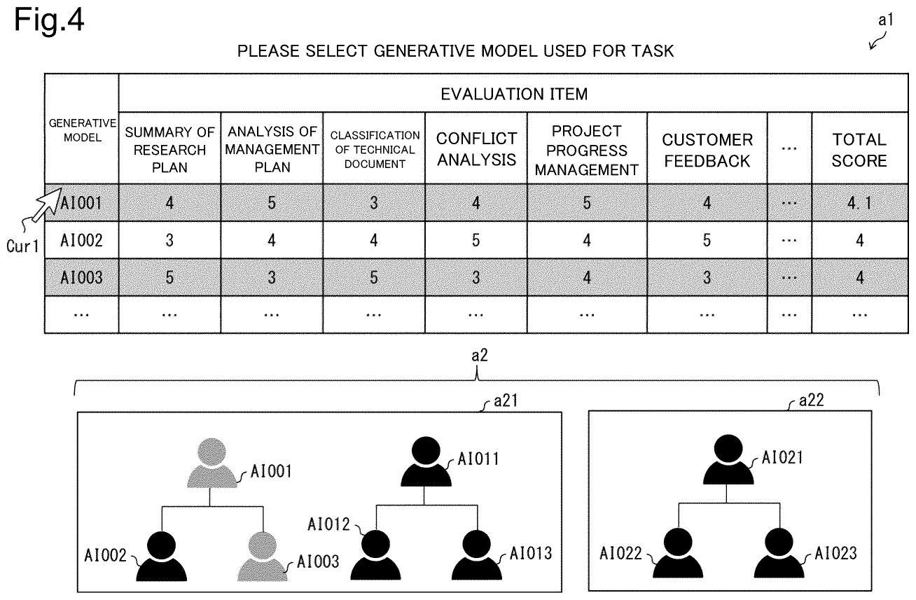

As described above, the user may designate the generative model 111A to be allocated to the target task. At this time, the presentation control unit 106A may display a UI screen that accepts designation of the generative model 111A. This will be described with reference to FIG. 4. FIG. 4 is a diagram illustrating an example of a UI screen that accepts designation of the generative model 111A. The UI screen illustrated in FIG. 4 includes a table a1 indicating the evaluation results of the plurality of generative models 111A and relationship information a2 indicating the relationship between each person based on the plurality of generative models 111A.

Table a1 shows evaluation results in a plurality of evaluation items for each of a plurality of generative models 111A identified by identification information such as “AI001”, “AI002”, and “AI003”. The presentation control unit 106A can generate the table a1 using the evaluation result 112A generated by the evaluation unit 104A. Hereinafter, the generative model 111A of “AI001” is referred to as a generative model AI001. The same applies to other models.

The evaluation items illustrated in FIG. 4 include a summary of the research plan, analysis of the management plan, classification of technical documents, conflict analysis, project progress management, customer feedback, and the like. These evaluation items are evaluated in five stages of 1 to 5, and the results are shown in the table a1. In the table a1, a value obtained by averaging these evaluation results is illustrated as the total score.

Summary of a study plan is the task of generating a summary of a study plan. Then, the evaluation result in the evaluation item of the summary of the research plan shown in the table a1 is obtained by causing the generative model 111A to execute the task. For example, whether main points can be accurately extracted from a complicated plan, whether there are a concise and easy-to-understand summary, and the like are evaluation criteria in this evaluation item. In this manner, by executing a task of summarizing documents in a specific field, it is possible to determine whether there is the suitability of the generative model 111A for the field.

Analysis of the contents of the management plan is a task of analyzing the contents of the management plan and extracting main strategies, risks, and financial plans. Understanding of the management plan, analysis ability, and the like are evaluation criteria in this evaluation item. The classification of the technical documents is a task of classifying the technical documents. The ability to accurately understand the technical contents and appropriately classify the technical contents is the evaluation criteria in this evaluation item. The technical document may be, for example, a specific type of document such as a patent document. The competition analysis is a task of identifying a competitor and comparing the competitor with the own company. The ability to identify appropriate competitors and accurately identify strengths and weaknesses of our company with respect to the competitors, and the like are the evaluation criteria in this evaluation item. The progress management of the project is a task of managing the project to proceed as scheduled. The ability to grasp the progress status of the project and take appropriate measures in a timely manner in such a way that the project proceeds as scheduled is the evaluation criteria in this evaluation item. The customer feedback is a task of analyzing a content of feedback from a customer. The ability to accurately grasp the customer's intention is the evaluation criteria in this evaluation item. For example, various tasks such as a task of evaluating a report summarizing the result of the competition analysis, a task of predicting the market situation, a task of creating a review of the report, a task of creating a new business proposal, a task of analyzing the technical report, and the like can be used for the evaluation of the generative model 111A.

In the example of FIG. 4, the acceptance unit 103A accepts designation of the generative model 111A via the table a1. Specifically, in the example of FIG. 4, the acceptance unit 103A accepts designation of two generative models 111A such as a generative model AI001 and a generative model AI003, by the cursor Curl. In the table a1, the fact that the rows associated with these models are displayed distinguishably from other rows indicates that designation for these models has been accepted. These generative models 111A designated by the user are allocated as the generative model 111A that executes the target task.

In the relationship information a2 illustrated in FIG. 4, each person who is the basis of the plurality of generative models 111A is indicated by an icon. The relationship information a2 is linked with the table a1. Therefore, in the relationship information a2, the icon of the person associated with the generative model 111A selected in the table a1 is displayed in such a way as to be distinguishable from the icon of the person associated with the unselected generative model 111A.

The acceptance unit 103A may accept designation of the generative model 111A via the table a1 and may accept designation of the generative model 111A by the user via the relationship information a2. That is, the acceptance unit 103A may accept an operation of designating the person (specifically, the icon in the example of FIG. 4) indicated in the relationship information a2 as an operation of designating the generative model 111A associated with the person. As a result, the user can easily designate the generative model 111A in consideration of the relationship between persons on which the plurality of generative models 111A is based.

In the relationship information a2 illustrated in FIG. 4, the relationship between persons based on the plurality of generative models 111A is indicated by frame lines a21 and a22. More specifically, in the relationship information a2, icons associated with persons having common attributes are displayed within the same frame line.

For example, both the icon of the person associated with the generative model AI001 and the icon of the person associated with the generative model AI002 are displayed inside the frame line a21. This indicates that these persons have a common attribute (for example, belong to the same company). On the other hand, the icon of the person associated with the generative model AI021 is displayed outside the frame line a21 and inside the frame line a22. This indicates that the relevant person has an attribute different from that of the person associated with the generative model AI001, the generative model AI002, or the like.

As described above, the presentation control unit 106A may present persons having common attributes in association with each other. As a result, the user can easily designate the generative model 111A in consideration of the attribute of each person who is the basis of the generative model 111A. For example, the user can easily designate a plurality of generative models 111A associated with persons having common attributes, and can easily designate a plurality of generative models 111A associated with persons having different attributes.

In the relationship information a2 illustrated in FIG. 4, a line segment connecting each icon is displayed as information indicating the relationship between each person who is the basis of the plurality of generative models 111A. For example, a line segment connecting the icon of the person associated with the generative model AI001 and the icon of the person associated with the generative model AI002 indicates that these persons have a relationship of a boss and a subordinate. In this manner, it is also possible to display each person who is the basis of the plurality of generative models 111A as a node and display the relationship between persons by an edge connecting the nodes, that is, to use the relationship information a2 as a knowledge graph. According to the knowledge graph, it is possible to express any relationship other than the relationship between the supervisor and the subordinate. The above nodes and edges can also be referred to as entities and relations, respectively.

When accepting the designation of the generative model 111A to be allocated to the target task, the presentation control unit 106A may present a result of analyzing the past input/output data and training data for the generative model 111A as the generative model 111A which is the allocation candidate. For example, the presentation control unit 106A may display a co-occurrence relationship designated by co-occurrence analysis of past input/output data and training data in a graph format. By displaying such a graph, it is possible to give the user information that is the characteristic of the generative model 111A and serves as a reference for determining the allocation.

As described above, the information processing apparatus 1A includes the presentation control unit 106A that presents the evaluation result to the user and the acceptance unit 103A that accepts designation of the generative model 111A by the user.

Then, the allocation unit 102A allocates the generative model 111A designated by the user to the target task. As a result, in addition to the effect obtained by the information processing apparatus 1, it is possible to achieve allocation reflecting the intention of the user while taking into account the evaluation results of the respective generative models 111A.

As described above, a person who is the basis of the generative model 111A may exist in each of the plurality of generative models 111A. In this case, the presentation control unit 106A may present, to the user, the relationship information indicating the relationship between each person on which the plurality of generative models 111A is based. As a result, in addition to the effect obtained by the information processing apparatus 1, it is possible to obtain an effect that the user can easily designate the generative model 111A in consideration of the relationship between the persons who are the basis of the plurality of generative models 111A.

### (Allocation Change)

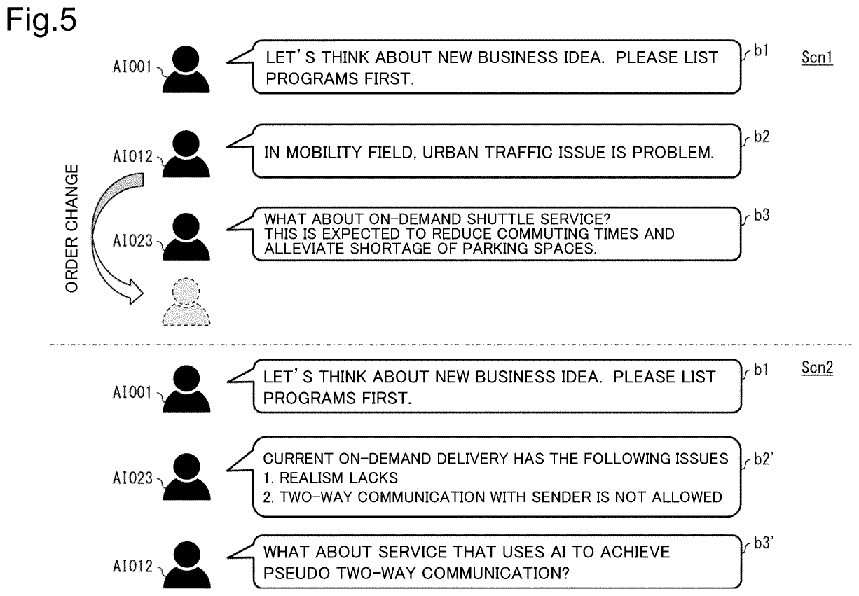

As described above, the acceptance unit 103A may accept an instruction to change the allocation of the generative model. This will be described with reference to FIG. 5. FIG. 5 is a diagram illustrating an example in which the allocation of the generative model is changed.

FIG. 5 illustrates two scenes Scn1 and Scn2. Among them, Scn1 indicates deliverables b1 to b3 generated by each generative model 111A when the target task is executed according to a first allocation (that is, the allocation before the change). Scn2 illustrates deliverables b1, b2′, and b3′ generated by each generative model 111A when the target task is executed according to the changed allocation. The target task in this example is the idea of a new business.

In the first allocation illustrated in Scn1, the generative model AI001 is allocated to the first process of the target task, the generative model AI012 is allocated to the second process, and the generative model AI023 is allocated to the third process.

In Scn1, first, in the first process, according to the allocation described above, the generative model AI001 generates, as the deliverable b1, a comment that encourages to mention a problem to be solved in the new business. For example, the execution control unit 105A may generate the deliverable b1 by inputting the target task, description of each process included in the target task, and a prompt for instructing to generate the deliverable in the first process to the generative model AI001. Specifically, the execution control unit 105A may input the following prompt to the generative model AI001. In this case, the character string (for example, a character string such as a deliverable b1 illustrated in FIG. 5) that is the deliverable is output in parentheses in the “deliverable: { }” of the prompt.

Exemplary prompt: “Three members cooperate to perform the following tasks. The task includes the following first to third processes. In the second and subsequent processes, deliverables are created using the deliverables of the preceding process. Please generate a deliverable in the first process that can lead to a good idea in the second and third processes.

Task: {creating new business ideas} process: {first process, second process, third process} deliverable of first process: { }”

The execution control unit 105A that has acquired the deliverable of the first process in this manner causes the generative model AI012 allocated to the second process to generate the deliverable of the second process. For example, the execution control unit 105A may input the following prompt to the generative model AI012. In this case, a character string (for example, a character string such as a deliverable b2 illustrated in FIG. 5) that is a deliverable is output in parentheses in the prompt “deliverable of second process: { }”.

Exemplary prompt: “Three members cooperate to perform the following tasks. The task includes the following first to third processes. In the second and subsequent processes, deliverables are created using the deliverables of the preceding process. Please generate a deliverable in the second process that can lead to a good idea in the third process, based on the deliverable in the first process.

Task: {creating new business ideas} process: {first process, second process, third process} deliverable of first process: {Consider new business ideas. Please list the problems first.} Deliverable of second process: { }”

Then, the execution control unit 105A that has acquired the deliverable of the second process causes the generative model AI023 allocated to the third process to generate the deliverable of the third process. For example, the execution control unit 105A may input the following prompt to the generative model AI023. In this case, a character string (for example, a character string such as a deliverable b3 illustrated in FIG. 5) that is a deliverable is output in parentheses in the prompt “deliverable of third process: { }”.

Exemplary prompt: “Three members cooperate to perform the following tasks. The task includes the following first to third processes. In the second and subsequent processes, deliverables are created using the deliverables of the preceding process. Please generate new business ideas as a deliverable in the third process based on the deliverables of the first and second processes.

Task: {creating new business ideas} process: {first process, second process, third process} deliverable of first process: {Consider new business ideas. Please list the problems first.} Deliverable of the second process: {In the field of mobility, urban traffic problems will be a problem.
} Deliverable of the third process: { }”

The presentation control unit 106A may present the character string that is the deliverable of the third process generated as described above to the user as the execution result of the target task. The presentation control unit 106A may also present an intermediate deliverable until the execution result of the target task is obtained, that is, the deliverable of the first process and the deliverable of the second process in the example of FIG. 5 to the user. In this case, as in the example of FIG. 5, the presentation control unit 106A may arrange and display the icons indicating the used generative models AI001, AI012, and AI023 in the order of use of the generative models, and display the deliverables (character strings in this example) generated by the respective generative models in association with the respective icons. As a result, it is possible to cause the user to confirm the validity of the progress in the middle of execution of the target task.

As described above, the information processing apparatus 1A includes the execution control unit 105A that causes the generative model 111A allocated to each process to generate the deliverable in each of the plurality of processes included in the target task, and causes the deliverable to be generated based on the deliverable generated in the preceding process in at least any of the second and subsequent processes. As a result, in addition to the effect obtained by the information processing apparatus 1, it is possible to obtain an effect that a final deliverable can be generated using a plurality of deliverables generated by a plurality of generative models 111A.

The presentation control unit 106A may present the deliverable generated by the generative model 111A in each of the plurality of processes included in the target task to the user. The acceptance unit 103A may accept an instruction to change the generative model 111A allocated to each of the plurality of processes. Then, in at least any of the second and subsequent processes in the changed allocation, the execution control unit 105A may cause the deliverable to be generated based on the deliverable generated in the preceding process. As a result, in addition to the effect obtained by the information processing apparatus 1, it is possible to accept an instruction to change the allocation based on the presented deliverable and generate a new deliverable reflecting the instruction to change the allocation.

For example, in Scn1 of FIG. 5, the acceptance unit 103A accepts an operation of moving the icon of the generative model AI012 after the icon of the generative model AI023. This operation is an operation of changing the execution order of the processing of the generative model AI012 and the generative model AI023, that is, an operation of instructing replacement of the generative model 111A allocated to the second process and the third process.

When such an operation is accepted, the execution control unit 105A re-executes the target task by applying the changed allocation. In Scn2 after re-execution, since the allocation is changed, deliverables in some processes are different from Scn1. Specifically, the deliverables in the second and third processes have changed to b2′ and b3′, respectively. The deliverable of the second process is changed to b2′ because the generative model 111A used in the second process is changed to the generative model AI023. The reason why the deliverable of the third process is changed to b3′ is that the deliverable of the second process preceding the third process is changed to b2′ in addition to the fact that the generative model 111A used in the third process is changed to the generative model AI012. As described above, in the example of FIG. 5, since the deliverable of each process can be changed by a simple and intuitive operation of changing the position of the icon, the user can easily generate a desired deliverable.

The acceptance unit 103A may accept an instruction to replace the generative model 111A used before the allocation change with the generative model 111A not used before the allocation change. In this case, the presentation control unit 106A may present a list of the generative models 111A that can be designated to the user. The acceptance unit 103A may accept an instruction to add the generative model 111A allocated to the target task or an instruction to delete a part of the generative model 111A allocated to the target task.

### (Flow of Processing)

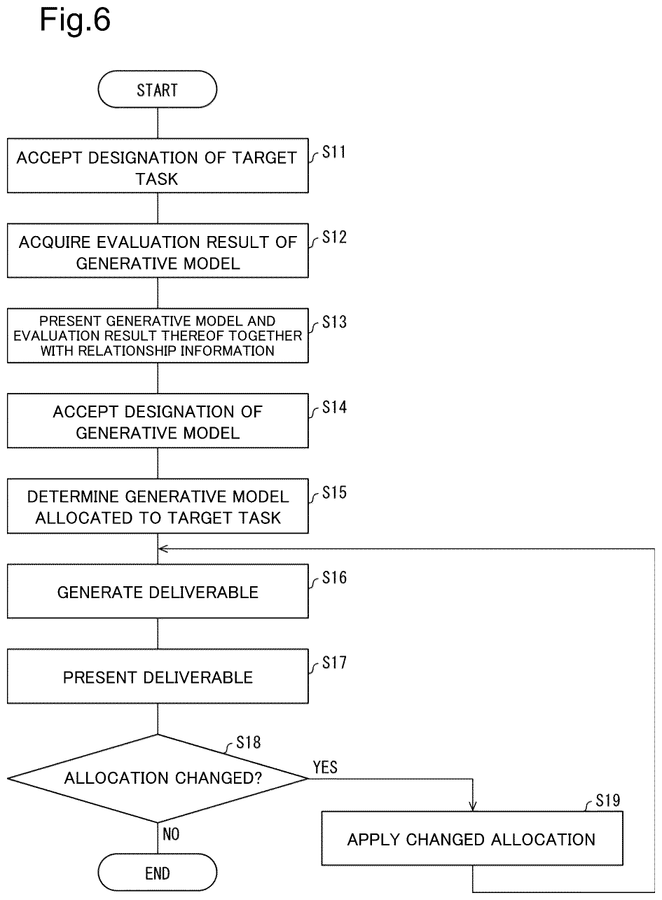

A flow of processing executed by the information processing apparatus 1A will be described with reference to FIG. 6. FIG. 6 is a flowchart illustrating a flow of processing executed by the information processing apparatus 1A. The flow of FIG. 6 includes each step of the allocation method according to the present example embodiment. In S11, the acceptance unit 103A accepts designation of the target task. The target task may be freely input in, for example, a text format, or a candidate of the target task may be presented to the user to designate the target task from among the candidates.

In S12 (evaluation result acquisition processing), the evaluation result acquisition unit 101A acquires the evaluation result 112A stored in the storage unit 11A. As described above, the evaluation result 112A is an evaluation result obtained by evaluating a plurality of generative models 111A subjected to machine learning in such a way as to execute a given task and generate a deliverable.

In S12, the evaluation unit 104A may evaluate each generative model 111A. In this case, the evaluation unit 104A functions as evaluation result acquisition means. In the case of evaluating the generative model 111A in S12, the evaluation unit 104A may evaluate each generative model 111A by applying an evaluation method associated with the target task accepted in S11. What kind of evaluation method is applied to what kind of target task may be determined in advance, or what kind of evaluation method is applied may be determined using a language model or the like. In the former case, for example, in a case where a process of generating an answer to a question is included in the target task, it may be defined that an evaluation method of evaluating the accuracy of the answer to the question is applied. In the latter case, for example, the target task, each applicable evaluation method, and the description of each evaluation method may be input to the language model, and the evaluation method to be applied to the evaluation of the target task may be output. The evaluation method to be applied may be designated by the user.

In S13, the presentation control unit 106A presents, to the user, each of the generative models 111A that are candidates to be allocated to the target task, and the evaluation result obtained in S12 for each of the generative models 111A, together with the relationship information indicating the relationship between the persons on which the generative models 111A are based. For example, the presentation control unit 106A may present each of the generative models 111A, the evaluation results thereof, and the relationship information to the user by displaying an image as illustrated in FIG. 4. The presentation of the relationship information is not essential.

In S14, the acceptance unit 103A accepts designation of the generative model 111A from the generative model 111A presented in S13. For example, the user may designate the generative model 111A via the input unit 13A, or may designate the generative model 111A from another device via the communication unit 12A.

In S15 (allocation processing), the allocation unit 102A determines a plurality of generative models 111A to be allocated to the target task based on the evaluation result in S12 regarding the target task to be executed. Specifically, the allocation unit 102A determines, as the generative model 111A to be allocated to the target task, the generative model 111A designated by the user in consideration of the evaluation result of S12 presented in S13.

In S16, the execution control unit 105A causes the generative model 111A to execute the target task according to the allocation determined in S15 to generate a deliverable. Here, in a case where the target task includes a plurality of processes, as described above, the execution control unit 105A may generate a deliverable based on a deliverable generated in a preceding process in the second and subsequent processes.

In S17, the presentation control unit 106A presents the deliverable generated in S16 to the user.

For example, as in the example of FIG. 5, the presentation control unit 106A may present not only the final deliverable for the target task but also a deliverable generated in a process in the middle.

In S18, the acceptance unit 103A determines whether there is an allocation change instruction. If YES is determined in S18, the processing proceeds to S19, and if NO is determined in S18, the processing of FIG. 6 ends. If NO is determined in S18, the processing may return to S11 to accept designation of a new target task. The instruction to change the allocation can be optionally set. For example, as in the example of FIG. 5, the acceptance unit 103A may accept an operation of moving the position of the icon of the person associated with the generative model 111A whose allocation is desired to be changed to the position associated with the process of the change destination as the allocation change instruction.

In S19, the execution control unit 105A applies the changed allocation. This post-processing returns to S16, and the execution control unit 105A causes each generative model 111A to generate a deliverable according to the changed allocation.

The processing of S13 and S14 may be omitted. In this case, in S15, the allocation unit 102A automatically allocates, to the target task, the generative model 111A of which the evaluation result regarding the target task satisfies the predetermined condition among the plurality of generative models 111A of which the evaluation result is acquired in S12. A part of the generative model 111A to be allocated to the target task may be designated by the user, and the other part may be automatically determined by the allocation unit 102A.

### Modifications

An executing entity of each processing described in the above-described example embodiments is optional, and is not limited to the above-described examples. For example, a system having functions similar to those of the information processing apparatuses 1 and 1A can be constructed by a plurality of apparatuses capable of communicating with each other. The execution subject of processing illustrated in the flowchart illustrated in FIG. 6 may be one device (also referred to as a processor) or a plurality of devices (also referred to as processors).

### [Example of Implementation by Software]

Some or all of the functions of the information processing apparatuses 1 and 1A may be achieved by hardware such as an integrated circuit (IC chip) or may be achieved by software.

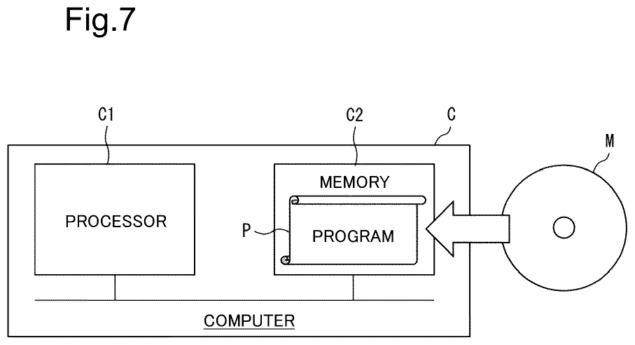

In the latter case, the information processing apparatuses 1 and 1A are implemented, for example, by a computer that executes a command of a program that is software for achieving each function. An example of such a computer (hereinafter, referred to as a computer C) is illustrated in FIG. 7. FIG. 7 is a block diagram illustrating a hardware configuration of the computer C that functions as the information processing apparatus 1 or 1A.

The computer C includes at least one processor C1 and at least one memory C2. In the memory C2, a program P for causing the computer C to operate as the information processing apparatus 1 or 1A is recorded. In the computer C, the processor C1 reads the program P from the memory C2 and executes the program P, thereby achieving the functions of the information processing apparatus 1 or 1A.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above-described functions of the information processing apparatuses 1 and 1A may be achieved by a single processor provided in a single computer, may be achieved by a plurality of processors provided in a single computer in cooperation, or may be achieved by a plurality of processors respectively provided in a plurality of computers in cooperation. The program for causing the information processing apparatus 1 or 1A to achieve each of the above-described functions may be stored in a single memory provided in a single computer, may be stored in a distributed manner in a plurality of memories provided in a single computer, or may be stored in a distributed manner in a plurality of memories respectively provided in a plurality of computers.

JP 2019-8483 A discloses causing a single AI (more specifically, a generative model such as a language model) to execute a task of communicating with a user, but there is no disclosure of executing one task by using a plurality of generative models in combination. If one task can be executed using a plurality of generative models in combination, it is also possible to execute a task that is difficult to execute with one generative model. Other various effects such as reduction in time required for completion of execution of the task and improvement in execution accuracy of the task can be expected.

However, in a case where a plurality of generative models is allocated to the task to be executed, if the allocated generative model is not appropriate, not only the above-described effect cannot be expected, but also the execution time of the task may be prolonged or the execution accuracy of the task may be deteriorated. For this reason, in a case where one task is executed using a plurality of generative models in combination, a technique for appropriately allocating the generative models is required, but such a technique is not known, and JP 2019-8483 A does not mention such a technique.

The present disclosure has been made in view of the above problems, and an exemplary object thereof is to provide a technique capable of appropriately allocating a plurality of generative models to a task to be executed.

According to an exemplary aspect of the present disclosure, there is an exemplary effect that a technology capable of appropriately allocating a plurality of generative models to a task to be executed can be provided.

### [Supplementary Note Item 1]

The present disclosure includes the techniques described in the following supplementary notes. However, the present disclosure is not limited to the techniques described in the following supplementary notes, and various modifications can be made within the scope described in the claims.

### (Supplementary Note A1)

An information processing apparatus including: an evaluation result acquisition unit that acquires an evaluation result obtained by evaluating a plurality of generative models subjected to machine learning in such a way as to execute a given task and generate a deliverable; and an allocation unit that determines a plurality of generative models to be allocated to a target task to be executed based on the evaluation result regarding the target task.

### (Supplementary Note A2)

The information processing apparatus according to Supplementary Note A1, in which the allocation unit allocates, to the target task, a generative model in which the evaluation result regarding the target task satisfies a predetermined condition among a plurality of generative models from which the evaluation result has been acquired.

### (Supplementary Note A3)

The information processing apparatus according to Supplementary Note A1 or A2, in which the allocation unit allocates a generative model to the target task based on attribute information indicating an attribute of each of the plurality of generative models.

### (Supplementary Note A4)

The information processing apparatus according to any one of Supplementary Notes A1 to A3, in which the allocation unit allocates the generative model to each of a plurality of processes included in the target task based on an evaluation result regarding each of the plurality of processes.

### (Supplementary Note A5)

The information processing apparatus according to Supplementary Note A1, further including: presentation control unit for presenting the evaluation result to a user; and acceptance unit for accepting designation of the generative model by the user, in which the allocation unit allocates the generative model designated by the user to the target task.

### (Supplementary Note A6)

The information processing apparatus according to Supplementary Note A5, in which each of the plurality of generative models includes a person on which the generative model is based, and the presentation control unit presents, to the user, relationship information indicating a relationship between the persons on which the plurality of generative models is based.

### (Supplementary Note A7)

The information processing apparatus according to any one of Supplementary Notes A1 to A6, further including execution control unit for causing the generative model allocated to each process to generate a deliverable in each of a plurality of processes included in the task, and generate the deliverable based on a deliverable generated in a preceding process in at least any of second and subsequent processes.

### (Supplementary Note A8)

The information processing apparatus according to Supplementary Note A7, further including: presentation control unit for presenting a deliverable generated by the generative model in each of the plurality of processes to a user; and acceptance unit for accepting an instruction to change the generative model to be allocated to each of the plurality of processes, in which the execution control unit causes a deliverable to be generated based on a deliverable generated in a preceding process in at least any of the second and subsequent processes in the changed allocation.

### (Supplementary Note B1)

An allocation method causing at least one processor to execute:
evaluation result acquisition processing for acquiring an evaluation result obtained by evaluating a plurality of generative models subjected to machine learning in such a way as to execute a given task and generate a deliverable; and
allocation processing for determining a plurality of generative models to be allocated to a target task to be executed based on the evaluation result regarding the target task.

### (Supplementary Note B2)

The allocation method according to Supplementary Note B1, in which the allocation processing includes causing the at least one processor allocates, to the target task, a generative model in which the evaluation result regarding the target task satisfies a predetermined condition among a plurality of generative models from which the evaluation result has been acquired.

### (Supplementary Note B3)

The allocation method according to Supplementary Note B1 or B2, in which the allocation processing includes causing the at least one processor to allocate a generative model to the target task based on attribute information indicating an attribute of each of the plurality of generative models.

### (Supplementary Note B4)

The allocation method according to any one of Supplementary Notes B1 to B3, in which the allocation processing includes causing the at least one processor to allocate the generative model to each of a plurality of processes included in the target task based on an evaluation result regarding each of the plurality of processes.

### (Supplementary Note B5)

The allocation method according to Supplementary Note B1, further causing the at least one processor to execute: presentation control processing for causing the at least one processor to present the evaluation result to a user; and causing the at least one processor to execute acceptance processing for accepting designation of the generative model by the user, in which the allocation processing includes causing the at least one processor to allocate the generative model designated by the user to the target task.

### (Supplementary Note B6)

The allocation method according to Supplementary Note B5, in which each of the plurality of generative models includes a person on which the generative model is based, and the at least one processor presents, to the user, relationship information indicating a relationship between the persons on which the plurality of generative models is based.

### (Supplementary Note B7)

The allocation method according to any one of Supplementary Notes B1 to B6, further including causing the at least one processor to execute execution control processing for causing the generative model allocated to each process to generate a deliverable in each of a plurality of processes included in the task, in which in at least any of second and subsequent processes, the execution control processing causes a deliverable to be generated based on a deliverable generated in a preceding process.

### (Supplementary Note B8)

The allocation method according to Supplementary Note B7, further causing the at least one processor to execute: presentation control processing for presenting a deliverable generated by the generative model in each of the plurality of processes to a user; and causing the at least one processor to execute acceptance processing for accepting an instruction to change the generative model to be allocated to each of the plurality of processes, in which the execution control processing includes causing the at least one processor to generate a deliverable based on a deliverable generated in a preceding process in at least any of the second and subsequent processes in the changed allocation.

### (Supplementary Note C1)

An allocation program causing a computer to function as: evaluation result acquisition means for acquiring an evaluation result obtained by evaluating a plurality of generative models subjected to machine learning in such a way as to execute a given task and generate a deliverable; and allocation means for determining a plurality of generative models to be allocated to a target task to be executed based on the evaluation result regarding the target task.

### (Supplementary Note C2)

The allocation program according to Supplementary Note C1, in which the allocation means allocates, to the target task, a generative model in which the evaluation result regarding the target task satisfies a predetermined condition among a plurality of generative models from which the evaluation result has been acquired.

### (Supplementary Note C3)

The allocation program according to Supplementary Note C1 or C2, in which the allocation means allocates a generative model to the target task based on attribute information indicating an attribute of each of the plurality of generative models.

### (Supplementary Note C4)

The allocation program according to any one of Supplementary Notes C1 to C3, in which the allocation means allocates the generative model to each of a plurality of processes included in the target task based on an evaluation result regarding each of the plurality of processes.

### (Supplementary Note C5)

The allocation program according to Supplementary Note C1, further causing the computer to function as: presentation control means for presenting the evaluation result to a user; and acceptance means for accepting designation of the generative model by the user, in which the allocation means allocates the generative model designated by the user to the target task.

### (Supplementary Note C6)

The allocation program according to Supplementary Note C5, in which each of the plurality of generative models includes a person on which the generative model is based, and the presentation control means presents, to the user, relationship information indicating a relationship between the persons on which the plurality of generative models is based.

### (Supplementary Note C7)

The allocation program according to any one of Supplementary Notes C1 to C6, further causing the computer to function as execution control means for causing the generative model allocated to each process to generate a deliverable in each of a plurality of processes included in the task, and generate the deliverable based on a deliverable generated in a preceding process in at least any of second and subsequent processes.

### (Supplementary Note C8)

The allocation program according to Supplementary Note C7, further causing the computer to function as: presentation control means for presenting a deliverable generated by the generative model in each of the plurality of processes to a user; and acceptance means for accepting an instruction to change the generative model to be allocated to each of the plurality of processes, in which the execution control means causes a deliverable to be generated based on a deliverable generated in a preceding process in at least any of the second and subsequent processes in the changed allocation.

### (Supplementary Note D1)

An information processing apparatus including at least one processor and causing the at least one processor to execute: evaluation result acquisition processing for acquiring an evaluation result obtained by evaluating a plurality of generative models subjected to machine learning in such a way as to execute a given task and generate a deliverable; and allocation processing for determining a plurality of generative models to be allocated to a target task to be executed based on the evaluation result regarding the target task.

The information processing apparatus may further include a memory. The memory may store a program causing the at least one processor to execute each of the processing.

### (Supplementary Note D2)

The information processing apparatus according to Supplementary Note D1, in which the allocation processing includes causing the at least one processor allocates, to the target task, a generative model in which the evaluation result regarding the target task satisfies a predetermined condition among a plurality of generative models from which the evaluation result has been acquired.

### (Supplementary Note D3)

The information processing apparatus according to Supplementary Note D1 or D2, in which the allocation processing includes causing the at least one processor to allocate a generative model to the target task based on attribute information indicating an attribute of each of the plurality of generative models.

### (Supplementary Note D4)

The information processing apparatus according to any one of Supplementary Notes D1 to D3, in which the allocation processing includes causing the at least one processor to allocate the generative model to each of a plurality of processes included in the target task based on an evaluation result regarding each of the plurality of processes.

### (Supplementary Note D5)

The information processing apparatus according to Supplementary Note D1, further causing the at least one processor to execute:
presentation control processing for presenting the evaluation result to a user; and acceptance processing for accepting designation of the generative model by the user, in which the allocation processing, the generative model designated by the user is allocated to the target task.

### (Supplementary Note D6)

The information processing apparatus according to Supplementary Note D5, in which each of the plurality of generative models includes a person on which the generative model is based, and the at least one processor presents, to the user, relationship information indicating a relationship between the persons on which the plurality of generative models is based.

### (Supplementary Note D7)

The information processing apparatus according to any one of Supplementary Notes D1 to D6, further causing the at least one processor to execute execution control processing for causing the generative model allocated to each process to generate a deliverable in each of a plurality of processes included in the task, in which the execution control processing for generating a deliverable is executed based on a deliverable generated in a preceding process in at least any of second and subsequent processes.

### (Supplementary Note D8)

The information processing apparatus according to Supplementary Note D7, further causing the at least one processor to execute:
presentation control processing for presenting a deliverable generated by the generative model in each of the plurality of processes to a user; and acceptance processing for accepting an instruction to change the generative model to be allocated to each of the plurality of processes, in which in at least any of the second and subsequent processes in the changed allocation, the execution control processing causes a deliverable to be generated based on a deliverable generated in a preceding process.

### (Supplementary Note E)

A non-transitory recording medium recording an allocation program for causing a computer to function as: evaluation result acquisition means for acquiring an evaluation result obtained by evaluating a plurality of generative models subjected to machine learning in such a way as to execute a given task and generate a deliverable; and allocation means for determining a plurality of generative models to be allocated to a target task to be executed based on the evaluation result regarding the target task.

1. An information processing apparatus comprising:
at least one memory storing instructions; and
at least one processor configured to access the at least one memory and execute the instructions to:
acquire an evaluation result obtained by evaluating a plurality of generative models subjected to machine learning in such a way as to execute a given task and generate a deliverable; and
determine a plurality of generative models to be allocated to a target task to be executed based on the evaluation result regarding the target task.

2. The information processing apparatus according to claim 1, wherein
the at least one processor is further configured to execute the instructions to:
allocate, to the target task, a generative model in which the evaluation result regarding the target task satisfies a predetermined condition among a plurality of generative models from which the evaluation result has been acquired.

3. The information processing apparatus according to claim 1, wherein
the at least one processor is further configured to execute the instructions to:
allocate a generative model to the target task based on attribute information indicating an attribute of each of the plurality of generative models.

4. The information processing apparatus according to claim 1, wherein
the at least one processor is further configured to execute the instructions to:
allocate a generative model to each of a plurality of processes included in the target task based on an evaluation result regarding each of the plurality of processes.

5. The information processing apparatus according to claim 1, wherein
the at least one processor is further configured to execute the instructions to:
present the evaluation result to a user; and
accept designation of the generative model by the user,
wherein the generative model is designated by the user to the target task.

6. The information processing apparatus according to claim 5, wherein
a person who is a base of the generative model exists in each of the plurality of generative models, and
the at least one processor is further configured to execute the instructions to:
present, to the user, relationship information indicating a relationship between persons on which the plurality of generative models is based.

7. The information processing apparatus according to claim 1, wherein
the at least one processor is further configured to execute the instructions to:
cause the generative model allocated to each process to generate a deliverable in each of a plurality of processes included in the task; and
generate the deliverable based on a deliverable generated in a preceding process in at least any of second and subsequent processes.

8. The information processing apparatus according to claim 7, wherein
the at least one processor is further configured to execute the instructions to:
present a deliverable generated by the generative model in each of the plurality of processes to a user;
accept an instruction to change the generative model to be allocated to each of the plurality of processes; and
cause a deliverable to be generated based on a deliverable generated in a preceding process in at least any of the second and subsequent processes in the changed allocation.

9. An allocation method causing at least one processor to execute:
evaluation result acquisition processing for acquiring an evaluation result obtained by evaluating a plurality of generative models subjected to machine learning in such a way as to execute a given task and generate a deliverable; and
allocation processing for determining a plurality of generative models to be allocated to a target task to be executed based on the evaluation result regarding the target task.

10. A non-transitory recording medium recording an allocation program for causing a computer to execute:
evaluation result acquisition step of acquiring an evaluation result obtained by evaluating a plurality of generative models subjected to machine learning in such a way as to execute a given task and generate a deliverable; and
allocation step of determining a plurality of generative models to be allocated to a target task to be executed based on the evaluation result regarding the target task.
